(19) United States
(12) Patent Application Publication
(10) Pub. No.: US 2015/0204046 A1
(43) Pub. Date: Jul. 23, 2015

(54) MANHOLE COVER LOCKING DEVICE

(71) Applicant: Jerry D. TAYLOR, Cincinnati, OH (US)

(72) Inventor: Jerry D. TAYLOR, Cincinnati, OH (US)

(21) Appl. No.: 14/600,681

(22) Filed: Jan. 20, 2015

Related U.S. Application Data
(60) Provisional application No. 61/928,564, filed on Jan. 17, 2014.

(51) Int. Cl. E02D 29/14; E05B 65/00; F16J 13/12

(52) U.S. Cl. CPC E02D 29/1427; F16J 13/12; E05B 65/006

(57) ABSTRACT

Locking devices and a method of installation are disclosed for securing a manhole cover which has not been previously secured to its associated mounting frame or casting. The locking device provides a means for the prevention of theft or vandalism of the manhole cover by unauthorized individuals. The locking device fits between the unsecured cover and the mounting frame for the cover by engaging an interior ledge, rim or supporting shoulder of the mounting frame beneath the cover at one end thereof, exiting between the outside circumference of the cover and the mounting, and then catching the exterior of the mounting frame outside the circumference of the manhole. A cover bolt passes through the access hole adjacent the outer circumference of the manhole cover and is screwed into a nut portion of the locking device.

### CROSS-REFERENCE TO RELATED APPLICATION

This application claims the benefit of U.S. Provisional Application No. 61/928,564, filed on Jan. 17, 2014, the disclosure of which is incorporated herein by reference.

### FIELD OF THE INVENTION

The present invention relates generally to locking devices for manhole covers to prevent their theft, and more particularly to locks for manhole covers located in areas away from paved roads.

### BACKGROUND OF THE INVENTION

Manhole covers are commonly located in both off-road areas and within paved roadways to allow access into underground utility lines. Such covers are commonly constructed out of cast iron and are usually mounted on an associated mounting frame which is embedded in the ground or in concrete pavement near the curb. An interior ledge, rim, ring or supporting shoulder of the associated frame supports the weight of the cover, which fits flush with the frame aperture, such that the cover can be readily removed if necessary. A substantial number of manhole covers have at least one U-shaped access hole adjacent the outer circumference of the manhole cover.

Traditionally, the weight of a manhole cover has been considered sufficient to maintain them on their mountings. However, in many parts of the world, the metal content of the manhole cover is considered worth stealing by the locals. Although manhole covers can be very heavy, weighing up to one-hundred fifty pounds, they are quite often removed from their mounting frames by unauthorized persons as an act of theft or vandalism. The large opening left behind represents a serious injury hazard to a person or a vehicle, and the stolen covers must be replaced, with consequent expense to the city.

A need has therefore developed for a less expensive, more generally useful manhole cover lock that is usable on existing designed manhole covers. Although lockable cover systems are known, standard heavy manhole covers which are lowered into their mounting frames and thereafter not locked or secured in any manner are still commonly used in many municipalities. Therefore, there is a need to secure manhole covers in place to prevent unauthorized removal and the subsequent hazards resulting from a stolen or unseated cover.

It would therefore be advantageous to provide a locking device for an unsecured manhole cover which provides strong locking capacity, and which utilizes an uncomplicated design that is easy to manufacture.

### SUMMARY OF TITLE INVENTION

The present invention provides a security locking device that can be easily installed on such unsecured covers so they may be locked to their mounting frames, for deterring would-be thieves or vandals from removing the cover.

A first aspect of the invention provides a locking device for securing an unsecured manhole cover to its associated mounting frame, the locking device comprising: (a) a body portion for engaging a supporting shoulder of the mounting frame for the manhole cover; (b) a frame catch portion for engaging the exterior of the mounting frame; and (c) a locking portion for securing the manhole cover onto its frame, wherein the locking device can be fitted onto an unsecured manhole cover and its associated mounting frame and locked in place.

A second aspect of the invention provides a locking device securing an unsecured manhole cover to its associated mounting frame, the locking device comprising: (a) a body portion comprising a fin portion and a distal section for engaging a supporting shoulder of the mounting frame for the manhole cover; (b) a frame catch portion, comprising: (i) a vertical portion for fitting between the outside circumference of the manhole cover and its mounting frame; (ii) an external horizontal portion; and (iii) an exterior bolt for engaging the exterior of the mounting frame; and (c) a locking portion, comprising: (i) a cover bolt that is passed through an access hole of the outer circumference of the manhole cover; (ii) a nut portion for receiving the cover bolt; and (iii) a washer for fitting between the head of the cover bolt and the manhole cover, wherein the locking device can be fitted onto an unsecured manhole cover and its associated mounting frame and locked in place.

A third aspect of the invention provides a method of installing a locking device for securing an unsecured manhole cover to its associated mounting frame, the method comprising the steps of: (a) positioning a body portion of a locking device to engage a supporting shoulder of a mounting frame for a manhole cover; (b) positioning a frame catch portion to engage the exterior of the mounting frame; (c) placing the manhole cover atop the supporting shoulder of the mounting frame; and (d) tightening a cover bolt into a nut portion of the locking device to secure the locking device to the manhole cover and its associated mounting frame.

These and further objects, features, advantages and characteristics of the locking device of the present invention will be more fully appreciated upon viewing the following drawings, detailed description of the preferred embodiments, and claims.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a plan view of a first embodiment of a locking device of the invention as it is intended to be attached to a manhole cover and its associated mounting frame.

FIG. 2A is a top view of the first embodiment shown in FIG. 1.

FIG. 2B is side view of the first embodiment shown in FIG. 1,

FIG. 3 is a plan view of a second embodiment of a locking device of the invention as it is intended to be attached to a manhole cover and its associated mounting frame.

FIG. 4A is top view of the second embodiment shown in FIG. 3.

FIG. 4B is a side view of the second embodiment shown in FIG. 3.

### DETAILED DESCRIPTION OF THE INVENTION

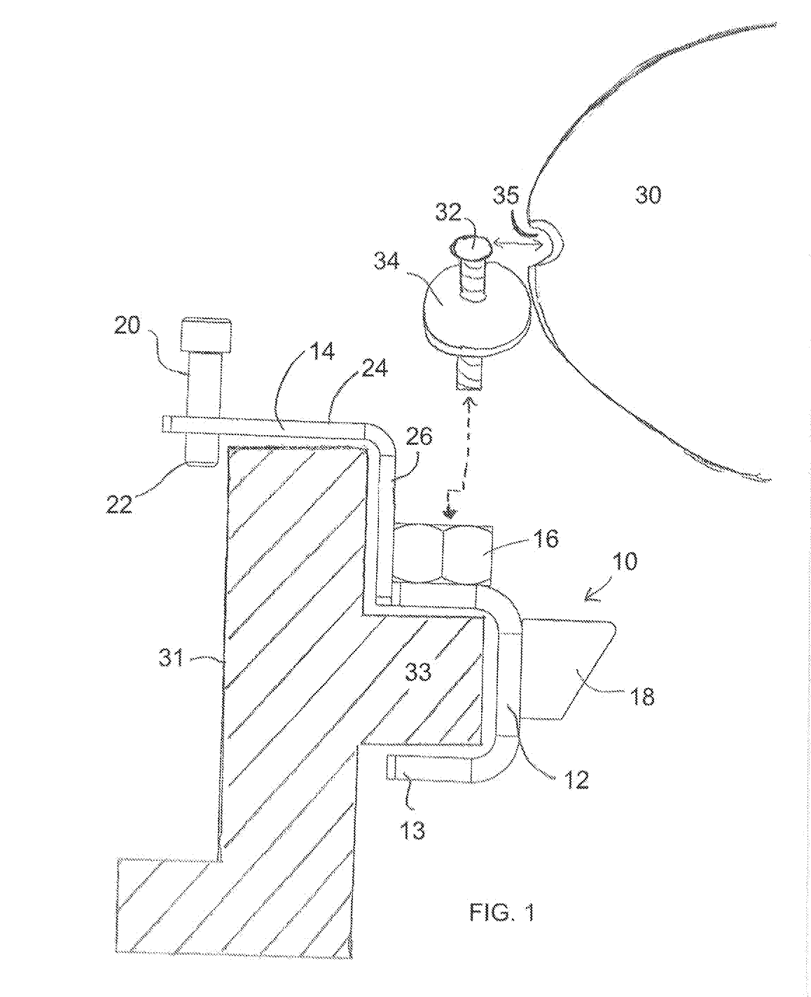

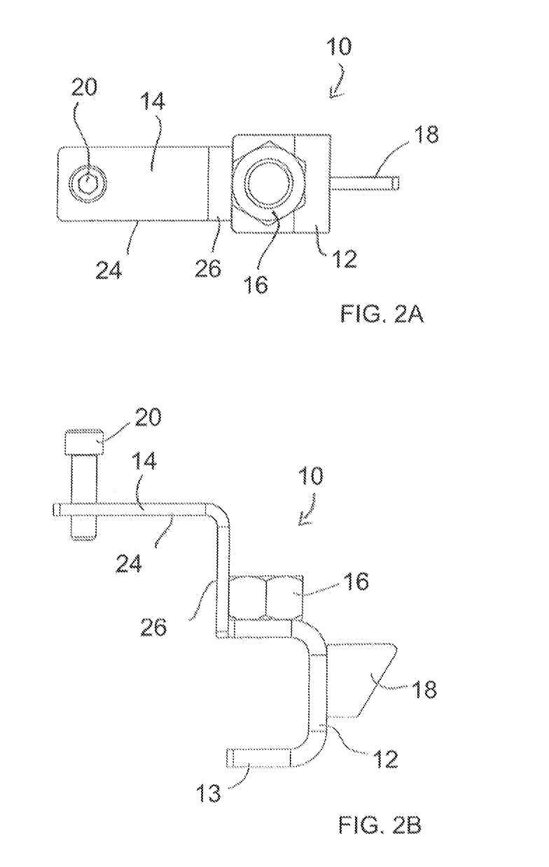

The present invention is a locking device for existing, unsecured removable sewer/manhole covers. FIGS. 1, 2A and 2B illustrate a first embodiment 10 of the locking device of the present invention as it is intended to be attached to a manhole cover 30 and its associated mounting frame 31. A body portion 12 fits around and/or engages an interior ledge, rim or supporting shoulder 33 of the mounting frame 31 for the manhole cover 30. A distal section 13 the body portion 12 of the locking device is designed to engage the undersurface of the notched interior ledge 33, as can be seen in FIG. 1. A frame catch portion 14 of the locking device 10 engages the exterior side of the mounting frame 31. The frame catch portion 14 typically includes a vertical portion 26 for fitting between the outside circumference of the manhole cover 30 and its mounting frame 31, an external horizontal portion 24, and an exterior bolt 20 for engaging the exterior side of the mounting frame. During manufacture, the exterior bolt 20 is initially screwed into or otherwise passed through a hole in the external horizontal portion 24, and then welded or otherwise fixedly attached to the external horizontal portion 24 of the frame catch 14.

Once the body portion 12 and frame catch portion 14 are fitted properly about the mounting frame 31, the manhole cover 30 is placed atop the supporting shoulder 33 of the mounting frame 31, and thus also atop a fin portion 18 of the locking device. This adds stability to the connection between the body portion 12 of the locking device 10 and the ledge 33 of the mounting frame 31. Adding further stability to the connection is the distal portion 22 of the exterior bolt 20, which engages the exterior portion of the mounting frame 31 as illustrated in FIG. 1.

The manhole cover is then locked, as follows. Nut 116 is part of a locking portion of the device 10, which also includes a cover bolt 32 and washer 34. The cover bolt 32 is screwed into the nut portion 16 after being passed through an access hole 35 of the outer circumference of the manhole cover 30. The outer circumference of the nut portion 16 is designed to tit within the access hole 35 when the manhole cover 30 is seated atop the mounting frame shoulder 33 and the fin 18. Washer 34 is placed between the head of the cover bolt 32 and the manhole cover 30. The cover bolt 32 typically includes a bolt head that requires a special wrench to screw/unscrew the bolt. Thus, only authorized personnel will have the correct wrench needed to access the cover bolt head and loosen the locking device.

Thus, as described above, the locking device 10 is installed by positioning the body portion 12 to engage the interior ledge 33 of the mounting frame 31, positioning the upper, frame catch portion 14 to engage the exterior of the mounting frame 31, placing the manhole cover 30 about the mounting frame's interior ledge 33, and then tightening the cover bolt 32 into the nut portion 16 to secure the locking device 10 to the manhole cover and its associated mounting frame. Typically the locking device can be fitted onto any existing, unsecured manhole cover and its associated mounting frame and locked in place.

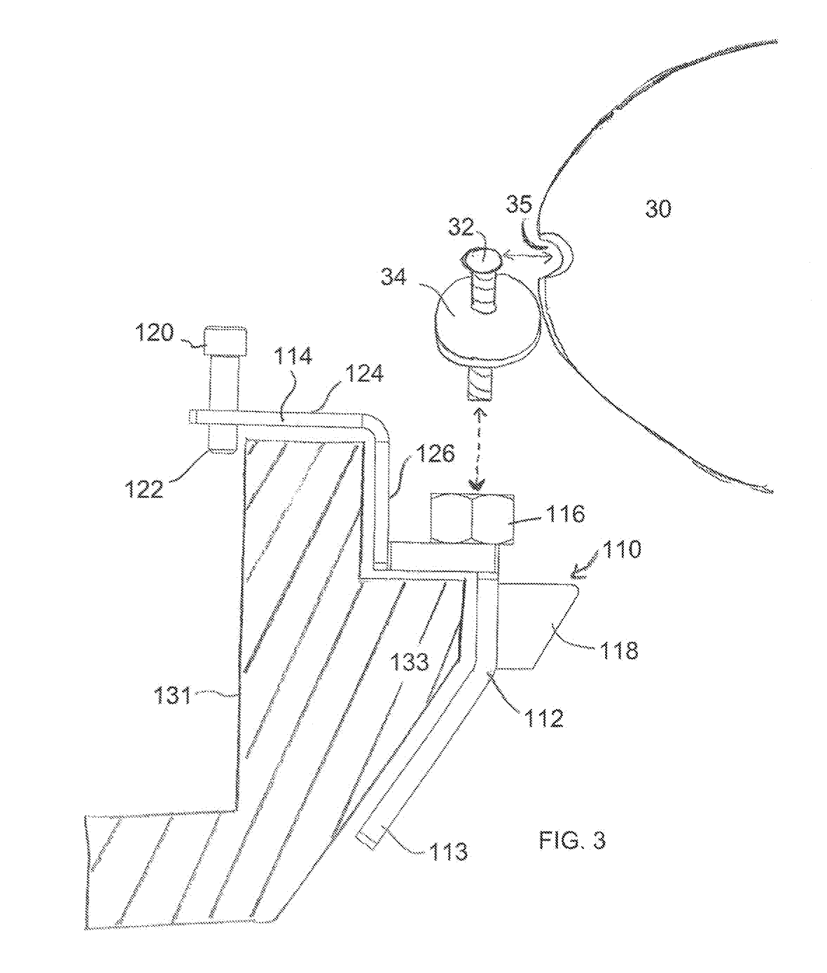

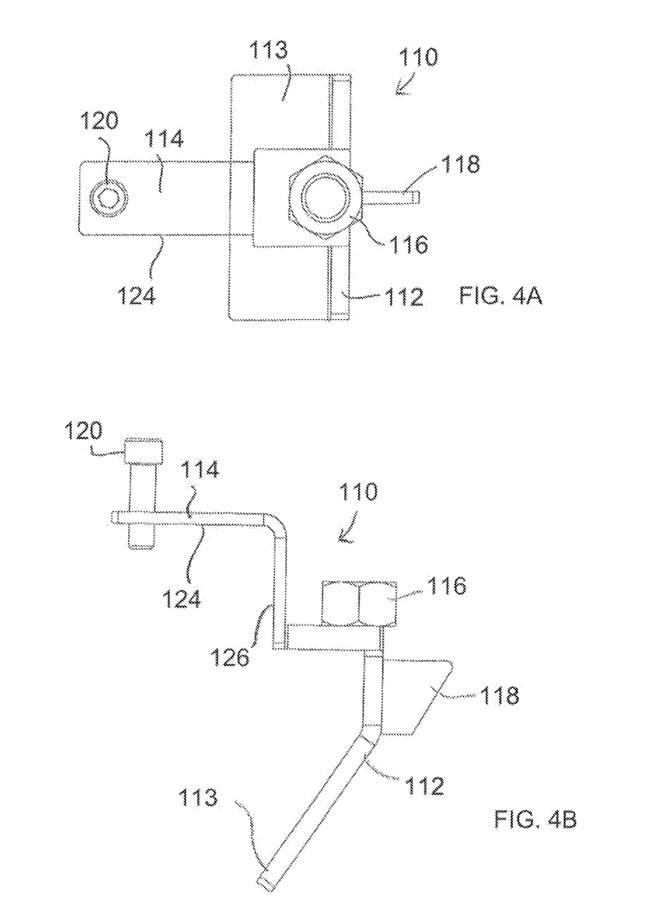

FIGS. 3, 4A and 4B illustrate a second embodiment 110 of the locking device of the present invention as it is intended to be attached to a manhole cover 30 and its associated. mounting frame 131. Here, the distal section 113 of the body portion 112 is designed to engage an interior ledge 133 of the mounting frame 131 that is angled rather than notched (as in FIG. 1). A frame catch portion 114 engages the exterior of the mounting frame, and typically includes a vertical portion 126 for fitting between the outside circumference of the manhole cover 30 and its mounting frame 131, an external horizontal portion 124, and an exterior bolt 120 for engaging the exterior side of the mounting frame. During manufacture, the exterior bolt 120 is initially screwed into or otherwise passed through a hole in the external horizontal portion 124, and then welded or otherwise fixedly attached thereto.

Once the body portion 112 and frame catch portion 114 are fitted properly about the mounting frame 131, the manhole cover 30 is placed atop the supporting shoulder 133 and thus also atop a fin portion 118 of the locking device. Nut 116 is part of the locking portion of the device 110, which also includes the cover bolt 32. Like the description for the first embodiment above, the cover bolt 32 is passed through the access hole 35 of the outer circumference of the manhole cover 30, and the nut portion 116 receives the cover bolt 32 for tightening thereto. The outer circumference of the nut portion 116 is designed to fit within the access hole 35 when the manhole cover 30 is seated atop the mounting frame shoulder 133 and the fin 118. Washer 34 is also used, fitting between the head of the cover bolt 32 and the manhole cover 30. Once in place, the manhole cover 30 is seated atop the fin portion 118 of the locking device, which adds stability to the connection between the body portion 112 of the locking device and the mounting frame 131. Adding further stability is the distal portion 122 of the exterior bolt 120, which engages the exterior of the mounting frame 131 and prevents the locking device from rocking about. As shown in FIGS. 1 and 3, the locking devices illustrated in FIGS. 2A, 2B, 4A and 49 can be removably secured to a standard manhole cover and its associated mounting frame.

It can be appreciated from comparing FIG. 4A to FIG. 2A that the body portion 112 of the second embodiment is much wider than the body portion 12 of the first embodiment. This helps the distal portion 113 of the second embodiment to more securely engage the angled. aspect of the mounting frame's shoulder 133. In practice, the body portion 12, 112 of the locking device 10, 110 is positioned to fit around and/or engage an interior ledge or shoulder 33, 133 of the mounting frame 31, 131 for the manhole cover 30. The frame catch portion 14 is then positioned for engaging the exterior of the mounting frame 31, 133; and then after the manhole cover is placed atop the shoulder 33, 133, the cover bolt 32 secures the locking device 10, 110 to the manhole cover 30 and its associated mounting frame 31, 133.

The cover bolt 32 shown in FIGS. 1 and 3 typically includes a bolt head which is specially configured in a manner known in the art, requiring a specially constructed wrench to unscrew the cover bolt for removing the lock, and thus for removing the manhole cover from its frame. Unauthorized persons are typically unable to obtain the specially constructed wrenches, which are only available to authorized sewer maintenance personnel for sewer clean-out or repair purposes.

The locking device of the invention is typically made of a high strength corrosion-resistant material such as metal, and can include a coating which further protects the metal against corrosion. Such coatings can be a powder coating (paint powder applied in an oven to form a continuous film over the metal) or a trivalent chromate coating. Trivalent chromates produce a harder, scratch-resistant coating with lower water content providing more heat resistance, The bolts are preferably made of stainless steel, and are typically about ⅜ inches to about ½ inches in diameter, for ensuring a strong locking engagement with the locking device and manhole cover.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope of the invention,

What is claimed is:

1. A locking device for securing an unsecured manhole cover to its associated mounting frame, the locking device comprising:
a) a body portion for engaging a supporting shoulder of the mounting frame for the manhole cover;
b) a frame catch portion for engaging the exterior of the mounting frame; and
c) a locking portion for securing the manhole cover onto its frame, wherein the locking device can be fitted onto an unsecured manhole cover and its associated mounting frame and locked in place.

2. The locking device of claim 1, wherein the body portion comprises a fin portion and a distal section.

3. The locking device of claim 1, wherein the frame catch portion comprises:
i) a vertical portion for fitting between the outside circumference of the manhole cover and its mounting frame;
ii) an external horizontal portion; and
iii) an exterior bolt for catching the exterior of the mounting frame.

4. The locking device of claim 1, wherein the locking portion comprises:
i) a cover bolt that is passed through an access hole of the outer circumference of the manhole cover;
ii) a nut portion for receiving the cover bolt; and
iii) a washer for fitting between the head of the cover bolt and the manhole cover.

5. The locking device of claim 4, wherein the cover bolt requires a special wrench to turn the cover bolt.

6. A locking device for securing an unsecured manhole cover to its associated mounting frame, the locking device comprising:
a) a body portion comprising a fin portion and a distal section for engaging a supporting shoulder of the mounting frame for the manhole cover;
b) a frame catch portion, comprising:
i) a vertical portion for fitting between the outside circumference of the manhole cover and its mounting frame;
ii) an external horizontal portion; and
iii) an exterior bolt for catching the exterior of the mounting frame ; and
c) a locking portion, comprising:
i) a cover bolt that is passed through an access hole of the outer circumference of the manhole cover;
ii) a nut portion for receiving the cover bolt; and
iii) a washer for fitting between the head of the cover bolt and the manhole cover, wherein the locking device can be fitted onto an unsecured manhole cover and its associated mounting frame and locked in place.

7. The locking device of claim 6, wherein the cover bolt requires a special wrench to turn the cover bolt.

8. A method of installing a locking device for securing an unsecured manhole cover to its associated mounting frame, the method comprising the steps of:
a) positioning a body portion of a locking device to engage a supporting shoulder of a mounting frame for a manhole cover;
b) positioning a frame catch portion of the locking device to engage the exterior of the mounting frame;
c) placing the manhole cover atop the supporting shoulder of the mounting frame; and
d) tightening a cover bolt into a nut portion of the locking device to secure the locking device to the manhole cover and its associated mounting frame.
